(19) United States
(12) Patent Application Publication
(10) Pub. No.: US 2009/0324376 A1
(43) Pub. Date: Dec. 31, 2009

(54) TROUGH HOIST APPARATUS AND ASSOCIATED METHOD

(76) Inventors: Dale K. Wells, Dayton, OH (US); Ankush B. Mittal, Sidney, OH (US)

Correspondence Address: THOMPSON HINE LLP;Intellectual Property Group, P.O Box 8801, DAYTON, OH, 45401-8801, US

(21) Appl. No.: 12/147,595

(22) Filed: Jun. 27, 2008

(51) Int. Cl. B66F 9/02

(52) U.S. Cl. 414/592; 414/814

(57) ABSTRACT

A trough hoist apparatus that raises, dumps and lowers dough troughs includes a column assembly comprising a first column and a second column spaced laterally from the first column. A first externally threaded screw is mounted within the first column such that the first threaded screw extends vertically along a height of the first column. A second externally threaded screw is mounted within the second column such that the second threaded screw extends vertically along a height of the second column. A first drive assembly includes a first internally threaded drive nut internally receiving the first threaded screw. The first drive assembly is configured to rotate the first drive nut relative to the first threaded screw to move the first drive assembly vertically along the first threaded screw. A second drive assembly includes a second internally threaded drive nut internally receiving the second threaded screw. The second drive assembly is configured to rotate the second drive nut relative to the second threaded screw to move the second drive assembly vertically along the second threaded screw. A trough carriage assembly is located between the first column and the second column. The trough carriage assembly is mounted to the first drive assembly and the second drive assembly for vertical movement therewith. The trough carriage is configured to receive a dough trough.

### TECHNICAL FIELD

This application relates generally to food handling systems and more particularly to a trough hoist system for lifting large amounts of dough.

### BACKGROUND

Trough hoists are used to raise, dump and lower dough troughs for feeding mixers, dough dividers or overhead forming equipment, as examples. For some commercial applications, bakeries may produce in the range of thousands of loaves of bread and other pastry items or hundreds of loaves of bread or pastry items per day. For bakeries on having the higher volumes, the trough hoists may have lifting capacities of up to 3,800 pounds or more. Lifting such large amounts of dough can put strain on load bearing members of the trough hoists.

### SUMMARY

In an aspect, a trough hoist apparatus that raises, dumps and lowers dough troughs includes a column assembly comprising a first column and a second column spaced laterally from the first column. A first externally threaded screw is mounted within the first column such that the first threaded screw extends vertically along a height of the first column. A second externally threaded screw is mounted within the second column such that the second threaded screw extends vertically along a height of the second column. A first drive assembly includes a first internally threaded drive nut internally receiving the first threaded screw. The first drive assembly is configured to rotate the first drive nut relative to the first threaded screw to move the first drive assembly vertically along the first threaded screw. A second drive assembly includes a second internally threaded drive nut internally receiving the second threaded screw. The second drive assembly is configured to rotate the second drive nut relative to the second threaded screw to move the second drive assembly vertically along the second threaded screw. A trough carriage assembly is located between the first column and the second column. The trough carriage assembly is mounted to the first drive assembly and the second drive assembly for vertical movement therewith. The trough carriage is configured to receive a dough trough.

In another aspect, a method of moving dough using a trough hoist apparatus is provided. The method includes placing a dough trough in a trough carriage assembly located between a first column and a second column of a column assembly comprising the first column and the second column spaced laterally from the first column. A first drive assembly to which the trough carriage assembly is mounted is driven. The first drive assembly includes a first internally threaded drive nut internally receiving a first threaded screw mounted in the first column. The first drive assembly rotates the first drive nut relative to the first threaded screw thereby moving the first drive assembly vertically along the first threaded screw. A second drive assembly to which the trough carriage is mounted is driven. The second drive assembly includes a second internally threaded drive nut internally receiving a second threaded screw mounted in the second column. The second drive assembly rotates the second drive nut relative to the second threaded screw thereby moving the second drive assembly vertically along the second threaded screw.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a side view of an embodiment of a trough hoist assembly that is used to feed a dough mixer with a trough carriage assembly of the trough hoist assembly in a lowered position;

FIG. 2 is a side view of the trough hoist assembly of FIG. 1 with the trough carriage assembly in a raised position;

FIG. 3 is a perspective view of the trough hoist assembly of FIG. 1;

FIG. 4 is a front view of the trough hoist assembly of FIG. 1;

FIG. 5 is a side view of an embodiment of a support column including drive assembly of the trough hoist assembly of FIG. 1;

FIG. 6 is a side view of an embodiment of a drive assembly for use with the trough hoist assembly of FIG. 1;

FIG. 7 is a diagrammatic, section view of the drive assembly of FIG. 6;

FIG. 8 illustrates a system and method of controlling the drive assemblies;

FIG. 9 is a perspective view of an embodiment of a clamp assembly;

FIG. 10 is an exploded view of the clamp assembly of FIG. 9;

FIG. 11 is a side view of the clamp assembly of FIG. 9; and

FIG. 12 is a side view of the clamp assembly received within an opening in the top of a support column.

### DETAILED DESCRIPTION

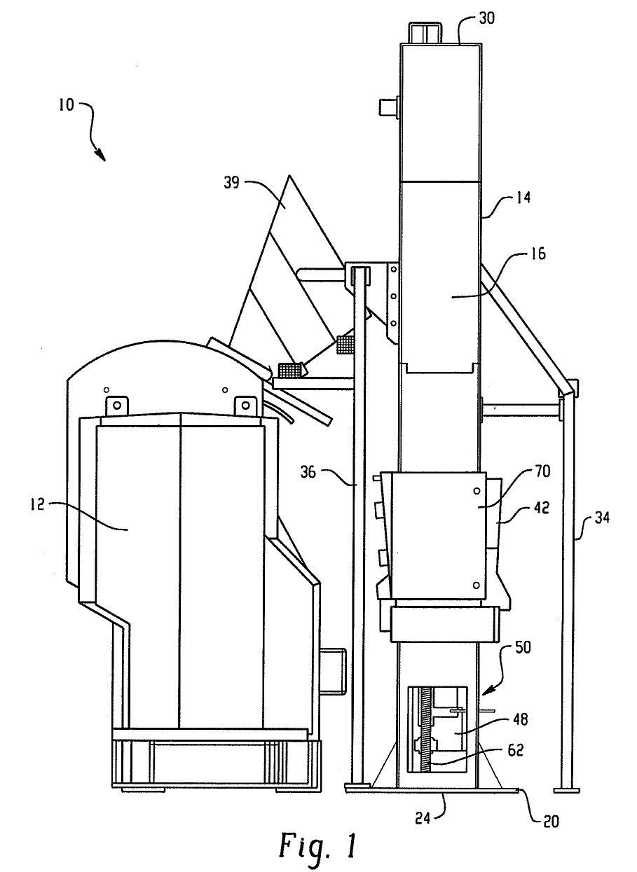

Referring to FIGS. 1-4, a trough hoist assembly 10 is used to raise, dump and lower dough troughs for feeding mixers, dough dividers or overhead forming equipment, as examples. In the illustrated example, the trough hoist assembly 10 is used to feed a dough mixer 12. A suitable dough mixer is a Roller Bar Mixer (e.g., model HS13FD or HS20FD), commercially available from Peerless Machinery Corp., Sidney, Ohio. Dough mixers can have various mixing capacities, for example, from 400 pounds to 3,200 pounds and can be suitable for mixing dough delivered from the trough hoist assembly 10 for making breads, rolls, buns, donuts, flour tortillas, croissants, sweet goods, pizza, English muffins and mixing low-absorption frozen doughs. The dough mixer 12 may include a refrigerated assembly such as that described in U.S. Pat. No. 6,047,558, the details of which are incorporated by reference. The refrigerated assembly can provide substantial temperature stabilization within the mixer during a dough mixing operation.

The trough hoist assembly 10 includes a column assembly 14 including a first support column 16 and a second support column 18 that is spaced laterally from the first support column. The first support column 16 is substantially the same height as the second support column 18, such as between about 150 inches to about 300 inches, such as about 210 inches.

The first and second support columns 16 and 18 include bases 20, 22 at a bottom 24, 26 of the support columns that maintain the hoist assembly 10 in its upright, vertical orientation. The support columns 16 and 18 are also connected together by a support bar 28 that is connected at a top 30, 32 of the first and second support columns. Secondary support columns 34, 35, 36 and 37 are provided for additional support, particularly during a dumping operation, which will be described in greater detail below.

A trough carriage assembly 38 is located between the first support column 16 and the second support column 18. The trough carriage assembly 38 includes a welded carriage 40 that removably receives and supports a dough trough 42. A dough trough is generally an elongated tub-like structure, which may include wheels and holds large amounts of dough to transport from one location to another.

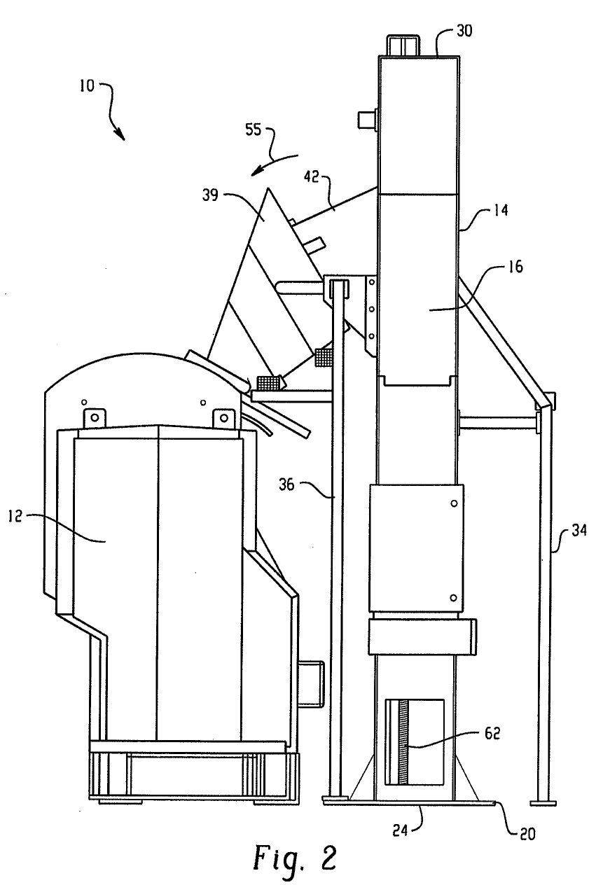

The trough carriage assembly 38 is moved vertically along the heights of the first and second support columns 16 and 18. FIG. 1 shows the trough carriage assembly 38 in a lowered position and FIG. 2 shows the trough carriage assembly in a fully raised, dumping position. In some embodiments, a dough chute 39 is provided to guide the dough into the dough mixer 12 during the dumping operation.

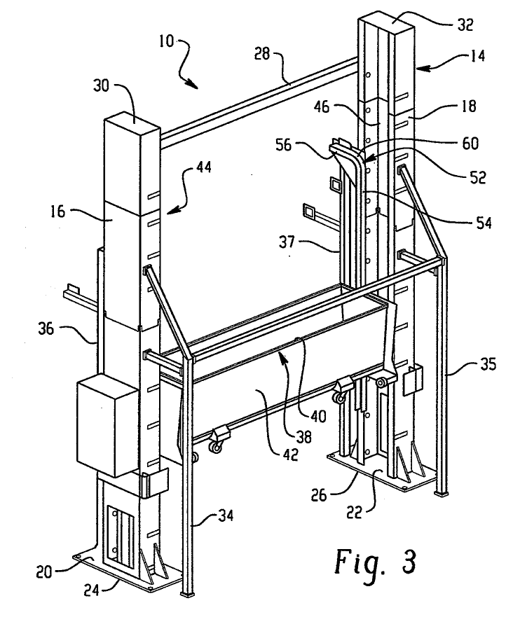

The support columns 16 and 18 include a channel 44 and 46 (see FIG. 3) that extends vertically along the heights of the first and second support columns between their tops 30, 32 and bottoms 24, 26. A first drive assembly 48 is located in the channel 44 of the first support column 16 and a second drive assembly 50 is located in the channel 46 of the second support column 18. The trough carriage assembly 38 is mounted to the first drive assembly 48 and the second drive assembly 50. The first and second drive assemblies 48 and 50 move the trough carriage assembly 48 along the heights of the first and second support columns 16 and 18 from the fully lowered position to the dumping position.

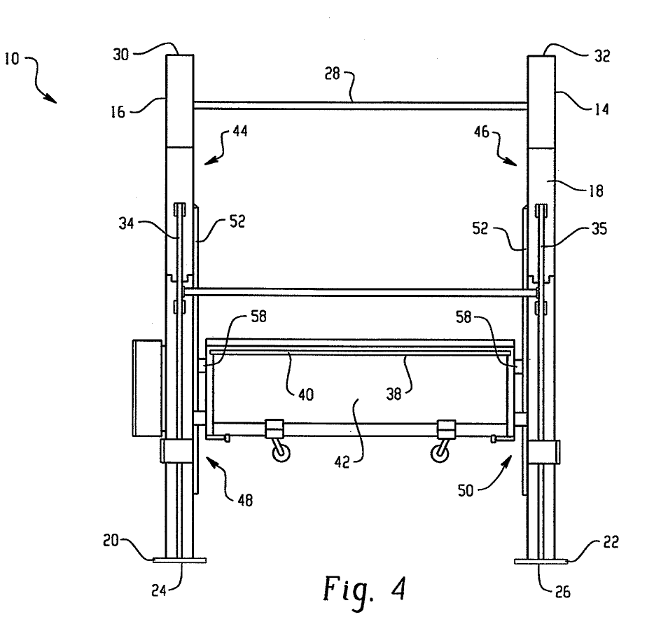

As can be seen by FIG. 2, the dough trough 42 is pivotable to provide a dumping action for the dough trough. Referring particularly to FIGS. 3 and 4, each support column 16 and 18 includes a track 52 having a vertical component 54 and a horizontal component 56. A wheel 58 or other suitable follower on each side of the dough trough 42 is received in each track 52 at the lower end of the track. The wheels 58 of the dough trough 42 ride along each component 54 and 56 of the track 52, the horizontal component 56 causing the dough trough to pivot forward in the direction of arrow 55 as the trough carriage assembly 38 is raised (see FIG. 2). The radius 60 of the track 52 is selected to provide a smooth transition of the dough trough 42 from its upright, vertical position to its dumping position. In some embodiments, an actuator, such as a pneumatic cylinder, is used to pivot the dough trough 42 forward relative to the trough carriage assembly 38 into the dumping position illustrated by FIG. 2 and to retract the dough trough back to its upright, vertical position shown by FIGS. 3 and 4.

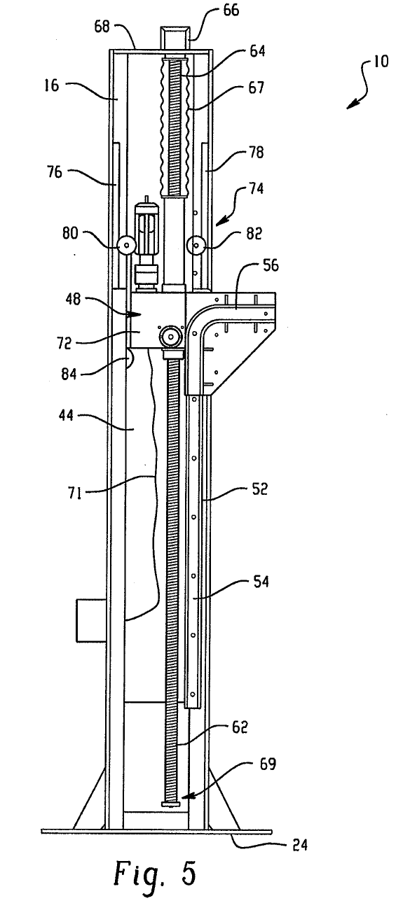

Referring to FIG. 5, first column 16 including drive assembly 48 is shown in isolation. Because drive assemblies 48 and 50 include the same components, only drive assembly 48 will be described in detail.

A threaded screw 62 (e.g., a 2″-3 RH ACME screw) is clamped at a top 64 of the threaded screw to the first support column 16 by a clamp assembly 66. In this embodiment, the threaded screw 62 is clamped to a top 68 of the first support column 16, however, the threaded screw 62 could be clamped to another wall that spans the channel 44, below the top 68.

The threaded screw 62 extends vertically along a height of the first support column 16 and is located within the channel 44 of the first support column. Threaded screw 62 is clamped by the clamp assembly 66 so that it does not rotate and such that an end 69 opposite the clamped end 64 hangs freely above the bottom 24, which enables some lateral movement of the threaded screw. As an alternative embodiment, the end 69 may be supported above the bottom 24 by a flexible, resilient bar of material such as a plastic or rubber rod extending upwardly from the bottom 24.

As described below, the drive assembly 48 moves vertically along the threaded screw 62 by rotating a driving nut relative to the threaded screw. A housing 72 of the drive assembly 48 is used to house various components of the drive assembly and is also a load bearing component of the drive assembly connecting the drive assembly to the trough carriage assembly 38. Sewn bellows 67 are provided for covering the threaded screw 62 as the drive assembly descends for inhibiting contaminants from collecting on the threaded screw.

A flexible cable carrier, represented by line 71, carries flexible cables from a control panel enclosure 70 (FIG. 1) to the drive assembly 48 for use in powering and controlling the drive assembly. The flexible cable carrier 71 and flexible cables move along with the drive assembly 48 along the height of the first column 16.

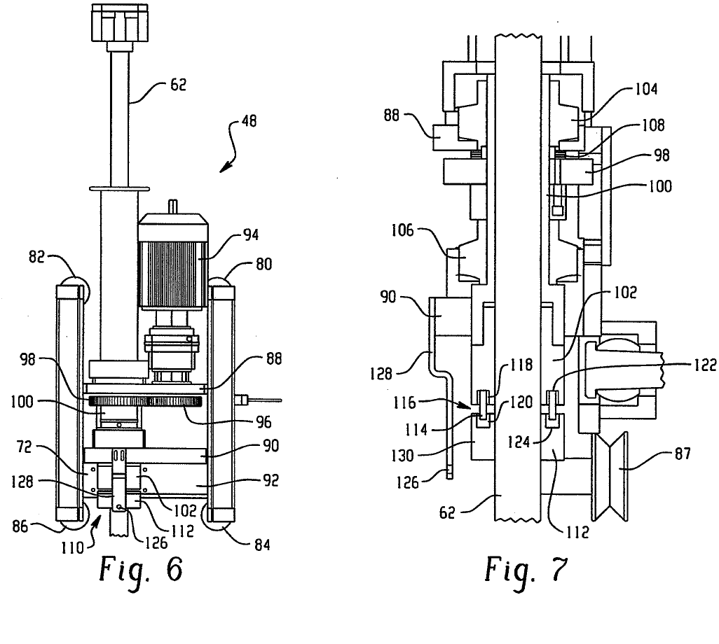

An adjustment assembly, generally referred to as element 74, is provided for guiding the drive assembly 48 within the channel 44 of the first column 16. The adjustment assembly 74 includes a pair of track members 76 and 78 located on opposite sides of the drive assembly 48. The track members 76 and 78 are V-shaped in cross-section and are engaged by upper rollers 80 and 82 and lower rollers 84 and 86 of the drive assembly 48, each of the rollers having a track engaging surface 87 (e.g., V-shaped; see FIG. 7) corresponding to the shape of the track members.

FIG. 6 shows the drive assembly 48 in isolation. The drive assembly 48 utilizes an offset drive system where the axial drive component is applied at a location offset vertically from the driving nut. Drive assembly 48 includes an upper connecting plate 88 and a lower connecting plate 90. The connecting plates 88 and 90 are connected to a load bearing plate 92 that forms a sidewall of the housing 72 to which the trough carriage assembly 38 is connected.

Mounted on the upper connecting plate 88 is a motor assembly 94 (e.g., a four HP drive gear motor). The motor assembly 94 is connected to a driving gear 96 for rotating the driving gear. The driving gear 96 rotates a driven gear 98, which is rigidly connected to a driven bushing 100 such that the driven bushing rotates with the driven gear. The driven bushing 100 is, in turn, rigidly connected to a driving nut 102, which is internally threaded and mates with the threads of the threaded screw 62.

Referring also to FIG. 7, the threaded screw 62 extends through the driving nut 102, driven bushing 100, driven gear 98 and the upper and lower connecting plates 88 and 90. The driven bushing 100 also extends from the driving nut 102, to which it is connected, through the driven bushing 100, driven gear 98 and the upper and lower connecting plates 88 and 90. Upper and lower radial load bearings 104 and 106 are provided above and below the driven gear 98 for offsetting or inhibiting any radial load from being transferred from the driving gear to the driving nut 102 through the driven bushing 100. This way, any load placed on the driving nut 102 is axial only due to the weight of the load being conveyed up the trough hoist assembly 10. This axial load arrangement can minimize binding between the driving nut 102 and the threaded screw 62 during use. The axial load acting on the driving system is offset or inhibited by thrust bearings 108 (e.g., needle roller thrust bearings). The driven gear 98 can be locked to the driving bushing 100 using a threaded set collar and retaining snap ring thereby preventing play therebetween.

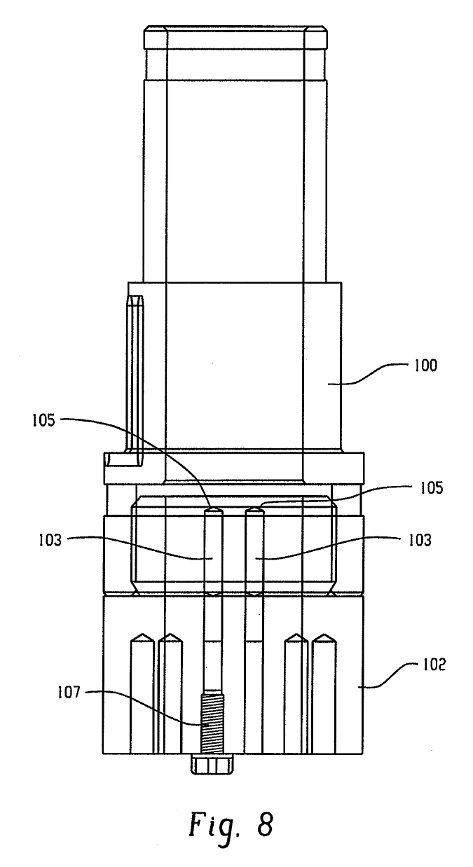

FIG. 8 shows the connection between the driving nut 102 and the driven bushing 100. The driven bushing 100 has internal threads only to a certain depth and the driving nut 102 has a flange with external threads which are engaged with the internal threads of the driven bushing. Pins 103 are press fit into drilled holes 105 to ensure that the driven bushing 100 and the driving nut 102 are interlocked and thereby preventing any cross rotation between them. The pins 103 are backed into the holes 105 by a set screw 107 to prevent the pins from backing out of the holes.

Referring back to FIGS. 6 and 7, the drive assembly 48 further includes a nut wear detection system, generally referred to as element 110, that is used to detect excessive wear on the driving nut 102. The nut wear detection system 110 includes an internally threaded back-up nut 112 that is threaded onto the threaded screw 62. The back-up nut 112 is also connected to the driving nut 102 by pins 114 such that the back-up nut 112 rotates with the driving nut and moves vertically with the driving nut to maintain a gap 116 (e.g., about ⅓ inch) therebetween. The pins 114 are press fit into recesses 118 in the driving nut 102 and are located within recesses 120 associated with the back-up nut 112. The recesses 118 and 120 of the driving nut 102 and the back-up nut 112 are sized to allow some vertical movement between the driving nut and the back-up nut. In other words, seating surfaces 122 and 124 of the recesses 118 and 120 are spaced-apart a distance that is greater than a length of the pins 114. In some embodiments, the seating surfaces 122 and 124 are spaced apart such that a gap of about one inch is provided below the pins 114.

A detector 126, such as a proximity sensor (e.g., a photoelectric sensor), is connected to the lower connecting plate 88 by a bracket 128. The bracket 128 is sized to position the detector 126 adjacent a lower edge 130 of the back-up nut 112 such that the detector detects the presence of the back-up nut during normal operation.

Because the driving nut 102 supports the weight of the drive assembly 48, when excessive wear on the driving nut occurs, the driving nut along with the housing 72 and the detector 126 drop down toward the back-up nut 112. The distance of the drop is sufficient to cause the detector 126 to no longer detect the presence of the back-up nut 112 as the detector drops below the lower edge 130.

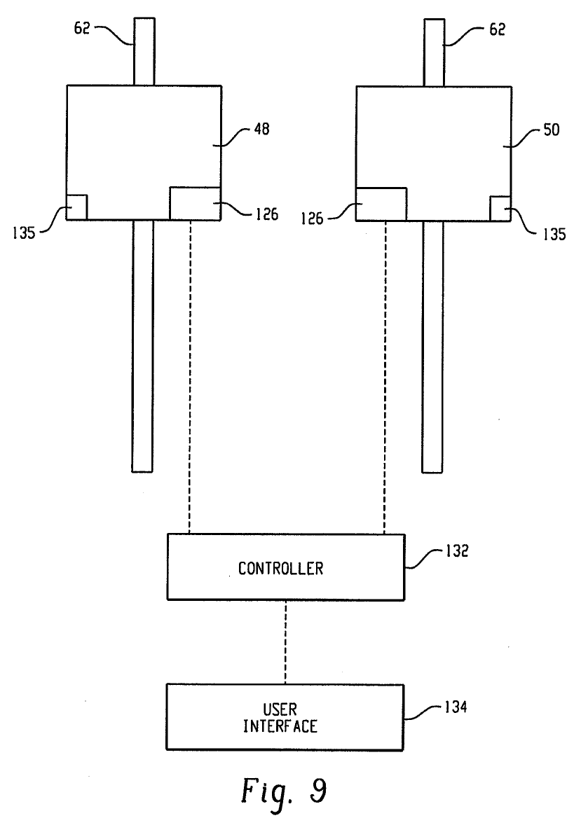

Referring now to FIG. 9, the detector 126 provides an excessive wear indication to a controller 132. The controller 132 is also connected to the first and second drive assemblies 48 and 50 for controlling operation and synchronization of the drive assemblies such that the drive assemblies ascend and descend along their respective threaded screws 62 together. In response to the excessive wear indication, the controller 132 can reverse the motor assemblies 94 of each of the first and second drive assemblies 48 and 50 to lower the trough carriage assembly 38 to its fully lowered, resting position. In some embodiments, the controller 132 may prevent further lifting of the trough carriage assembly 38 until the driving nut 102 is replaced and the detector 126 detects the presence of the back-up nut 112. A user input 134 is provided for user control of the trough hoist assembly 10, such as ON/OFF, speed and direction of travel controls.

A position sensor 135 is provided for determining vertical position of the first and second drive assemblies 48 and 50. Any suitable position sensor may be used (e.g., a string potentiometer) and the sensor 135 provides a signal to the controller 132 indicative of position of the respective drive assembly 48, 50. The controller 132 uses this position information to synchronize movement of the drive assemblies 48 and 50 to ensure they are at substantially the same elevation.

The driving and back-up nuts 102 and 112 can be formed of any suitable material such as AMPCO® 18 bronze. In some embodiments, the driving nuts 102 are turned at a maximum speed of 346 RPM using the motor assemblies 94 and controller 132. The lead of the threaded screws 62 can be ⅓ inch which provides a maximum linear speed of 117 in/min for the drive assemblies 48 and 50 in the direction of travel.

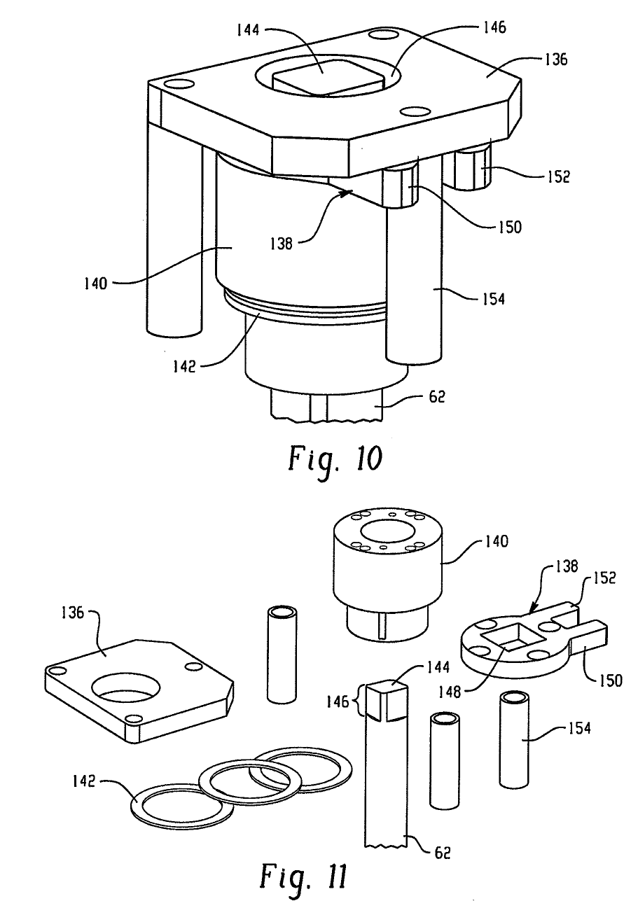

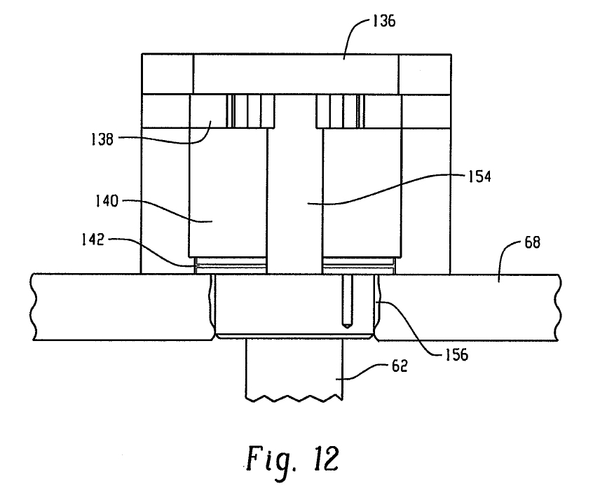

FIGS. 10-12 show the clamp assembly 66 used to clamp the top ends of the threaded screws 62 to their respective first and second support column. The clamp assembly 66 includes a top clamp plate 136, a fork plate 138, a top mount 140 and thrust bearings 142. An upper end 144 of the threaded screw 62 extends upwardly through the top mount 140 and an opening 146 in the top clamp plate 136. The upper end 144 of the threaded screw 62 has a square cut portion 146 that is received in a correspondingly-shaped opening 148 in the fork plate 138 located between the top clamp plate 136 and the top mount 140. The fork plate 138 includes a pair of prongs 150 and 152 that are spaced apart from each other to receive a mount spacer 154 therebetween to prevent rotation of the fork plate and the threaded screw 62. The clamp assembly 66 is received within an opening 156 in the top 68 of the support column (see FIG. 12). The mount spacers 154 are bolted to the top 68 of the support columns.

The clamp assembly 66 prevents rotation of the threaded screw 62 as the drive assembly 48 moves up and down along the height of the threaded screw while mounting the threaded screw above the bottom of the respective column such that the opposite end of the screw hangs freely above the floor. The clamp assembly 66 does allow some side-to-side movement of the threaded screw 62 which can inhibit binding of the drive assembly 48 as it moves along the threaded screw.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application.

What is claimed is:

1. A trough hoist apparatus that raises, dumps and lowers dough troughs, the trough hoist apparatus comprising:
a column assembly comprising a first column and a second column spaced laterally from the first column;
a first externally threaded screw mounted within the first column such that the first threaded screw extends vertically along a height of the first column;
a second externally threaded screw mounted within the second column such that the second threaded screw extends vertically along a height of the second column;
a first drive assembly including a first internally threaded drive nut internally receiving the first threaded screw, the first drive assembly configured to rotate the first drive nut relative to the first threaded screw to move the first drive assembly vertically along the first threaded screw;
a second drive assembly including a second internally threaded drive nut internally receiving the second threaded screw, the second drive assembly configured to rotate the second drive nut relative to the second threaded screw to move the second drive assembly vertically along the second threaded screw; and
a trough carriage assembly located between the first column and the second column, the trough carriage assembly mounted to the first drive assembly and the second drive assembly for vertical movement therewith, the trough carriage configured to receive a dough trough.

2. The trough hoist apparatus of claim 1, wherein the first threaded screw is clamped at one end to the first column, the opposite end of the first threaded screw hanging free at a location above the bottom of the first column.

3. The trough hoist apparatus of claim 2, wherein the second threaded screw is clamped at one end to the second column, the opposite end of the second threaded screw hanging free at a location above the bottom of the second column.

4. The trough hoist apparatus of claim 3, wherein the first threaded screw and the second threaded screw are clamped at one end such that the first threaded screw and the second threaded screw do not rotate with their associated first drive nut and second drive nut.

5. The trough hoist apparatus of claim 1, wherein the first drive assembly comprises
a first motor including an output shaft;
a first driving gear connected to the output shaft of the first motor such that the first motor rotates the first driving gear;
a first driven gear operatively linked to the first driving gear for rotation therewith;
a first driven bushing connected to the first driven gear such that the first driven bushing rotates with the first driven gear, the first driven bushing including a bore through which the first threaded screw extends, the first driven bushing connected to the first driving nut such that the first driving nut rotates with the first driven bushing.

6. The trough hoist apparatus of claim 5, wherein the second drive assembly comprises
a second motor including an output shaft;
a second driving gear connected to the output shaft of the second motor such that the second motor rotates the second driving gear;
a second driven gear operatively linked to the second driving gear for rotation therewith;
a second driven bushing connected to the second driven gear such that the second driven bushing rotates with the second driven gear, the second driven bushing including a bore through which the second threaded screw extends, the second driven bushing connected to the second driving nut such that the second driving nut rotates with the second driven bushing.

7. The trough hoist apparatus of claim 5 further comprising a back-up nut located below the first driving nut and including an opening through which the first threaded screw extends, the back-up nut being linked to the first driving nut for rotation therewith such that in the event of excessive thread wear of the first driving nut, the back-up nut configured to support the first drive assembly during use.

8. The trough hoist apparatus of claim 7, wherein, upon excessive thread wear of the first driving nut, the first driving nut disengages threads of the first threaded screw and drops vertically so that the back-up nut supports the first driving assembly thereon.

9. The trough hoist apparatus of claim 8 further comprising a detector arranged and configured to detect when the first driving nut drops vertically relative to the back-up nut.

10. The trough hoist apparatus of claim 1 further comprising first bellows having an opening extending therethrough through which the first threaded screw extends, the first bellows having a lower end connected to the first drive assembly so that the lower end moves with the first drive assembly.

11. The trough hoist apparatus of claim 1 further comprising a controller configured to synchronize movement of the first drive assembly and the second drive assembly.

12. The trough hoist apparatus of claim 1 further comprising an adjustment assembly configured to guide the first drive assembly within the channel of the first column.

13. The trough hoist apparatus of claim 1 further comprising
a dough trough removably received and carried by the trough carriage assembly; and
a track associated with the at least one of the first column and the second column, the track having a component that causes tilting of the trough carriage assembly for a dumping operation.

14. The trough hoist apparatus of claim 11 further comprising one or more position transducers arranged and configured to detect the linear position of one or both of the first drive assembly and the second drive assembly.

15. The trough hoist assembly of claim 14, wherein the position transducer is a string potentiometer.

16. A method of moving dough using a trough hoist apparatus, the method comprising:
placing a dough trough in a trough carriage assembly located between a first column and a second column of a column assembly comprising the first column and the second column spaced laterally from the first column;
driving a first drive assembly to which the trough carriage assembly is mounted, the first drive assembly including a first internally threaded drive nut internally receiving a first threaded screw mounted in the first column, the first drive assembly rotating the first drive nut relative to the first threaded screw thereby moving the first drive assembly vertically along the first threaded screw; and
driving a second drive assembly to which the trough carriage is mounted, the second drive assembly including a second internally threaded drive nut internally receiving a second threaded screw mounted in the second column, the second drive assembly rotating the second drive nut relative to the second threaded screw thereby moving the second drive assembly vertically along the second threaded screw.

17. The method of claim 16 further comprising clamping the first threaded screw at one end to the first column, the opposite end of the first threaded screw hanging free at a location above the bottom of the first column.

18. The method of claim 17 further comprising clamping the second threaded screw at one end to the second column, the opposite end of the second threaded screw hanging free at a location above the bottom of the second column.

19. The method of claim 16 further comprising
driving a first driving nut using a first motor;
driving a first driven gear operatively linked to the first driving gear for rotation therewith; and
driving a first driven bushing connected to the first driven gear such that the first driven bushing rotates with the first driven gear, the first driven bushing including a bore through which the first threaded screw extends, the first driven bushing connected to the first driving nut such that the first driving nut rotates with the first driven bushing.

20. The method of claim 19 further comprising linking a back-up nut to the first driving nut, the back-up nut including an opening through which the first threaded screw extends, the back-up nut being linked to the first driving nut for rotation therewith such that in the event of excessive thread wear of the first driving nut, the back-up nut supporting the first drive assembly during use.

21. The method of claim 20, wherein, upon excessive thread wear of the first driving nut, the first driving nut disengaging threads of the first threaded screw and dropping vertically so that the back-up nut supports the first driving assembly thereon.

22. The method of claim 21 further comprising detecting when the first driving nut drops vertically relative to the back-up nut using a detector.

23. The method of claim 22 further comprising the detector providing an excessive wear indication to a controller in response to the vertically dropping of the driving nut relative to the back-up nut, the controller lowering the first and second drive assemblies to their fully lowered position in response to the excessive wear indication.
